(19) United States
(12) Patent Application Publication
(10) Pub. No.: US 2014/0054896 A1
(43) Pub. Date: Feb. 27, 2014

(54) HYBRID SOLAR-WIND POWERED POWER STATION

(71) Applicant: Seng-Hong Ung, Sucy en Brie (FR)

(72) Inventor: Seng-Hong Ung, Sucy en Brie (FR)

(21) Appl. No.: 14/007,071

(22) PCT Filed: Mar. 22, 2012
(86) PCT No.: PCT/FR2012/000100

§ 371 Date: Nov. 7, 2013

(30) Foreign Application Priority Data
Mar. 24, 2011 (FR) 11/00882
Apr. 20, 2011 (FR) 11/01233

(51) Int. Cl. H02K 7/18

(52) U.S. Cl. CPC H02K 7/1823
USPC 290/54

(57) ABSTRACT

The power station includes a collector (5) of air heated by solar radiation (R, S) during the day, the collector having a distal end (6) open towards the ambient surroundings, and an opposite, proximal end (8) in communication with a chimney (1), a series of turbines designed to drive a set of electric generators (12) being interposed between the proximal end (10) of the chimney (1), characterized in that the turbines are magnetically supported turbines with a vertical axis of rotation (7).

The present invention relates to a hybrid solar-wind power station.

More particularly, the invention relates to a power station of the type comprising a collector of air heated by solar radiation during the day, said collector having a distal end open towards the surrounding environment, and an opposite, proximal end in communication with a chimney, a series of turbines designed to drive an electric generator assembly being interposed between said proximal end and said chimney.

The principle implemented is that of circulating air which occurs naturally from a warmer region (at the collector) towards a colder region (at the top of the chimney), the region being colder the higher the chimney is, and it is this circulation of air which drives the turbines in rotation. The rotation of the turbines, for its part, drives a generator assembly which thus produces electricity.

The power station is thus simultaneously solar powered, in the sense that at the floor, it is the sun which heats the air, and wind powered, in the sense that it is the current of air generated by the difference in temperature between the interior of the collector and the top of the chimney which makes the turbines rotate.

A power station of this type was conceived of in WO 2008/022372, but, as is known to the applicants, no corresponding construction was produced. Moreover, unless there has been a mistake, this PCT application did not lead to entry into the national or regional phase, and therefore the project has presumably been abandoned. Indeed, the reason for this is probably that the type of turbine which is intended to operate this power station is either only capable of producing an insignificant amount of power relative to the size of the power station, or requires the power station to be extremely large.

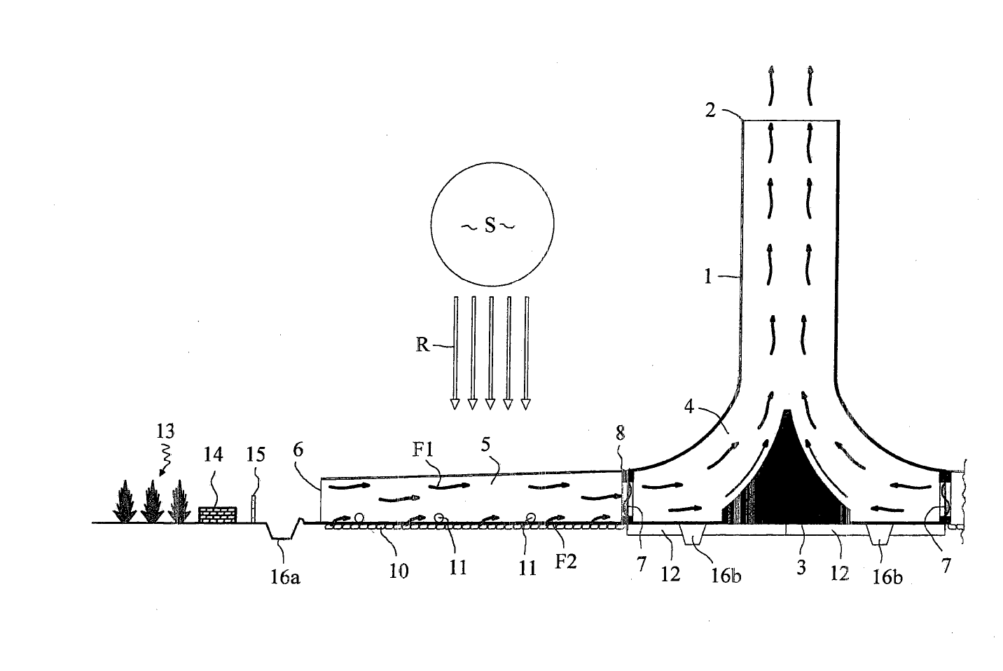

WO 2008/022372 does not specify the type of turbine which is intended to be used, but it shows, without a doubt, that it relates to turbines rotating about a horizontal axis (FIG. 1; reference numerals 90, 95).

The aim of the present invention is that of providing a hybrid solar-wind power station which is cable of supplying approximately 250 MW/h of power.

Horizontal-axis turbines are predominantly used in wind turbines, and the size of their blades can be considerable (up to 180 metres at the tip of the blade), for a fairly modest amount of power produced (6 MW/h). In other words, in order to obtain 250 MW/h, more than forty turbines are required, which, arranged in a circle, would form a minimum perimeter of approximately 200 m×40=8 km, or a diameter of greater than 2.5 km. If the size of the collector is added, the surface area occupied by the power station would be enormous.

It is clear that if, in order to attempt to reduce the size of the power station, it is envisaged to use smaller horizontal-axis turbines, such as those shown in WO 2008/022372, either an unreasonable number of turbines would be required (a small wind turbine produces less than 36 kW/h), or the power produced would be significantly less than the objective sought by the present invention.

The present invention solves this problem by substituting turbines having a horizontal axis of rotation with magnetically levitated turbines having a vertical axis of rotation.

Turbines of this type are known, for example, from CN 101761454. Said turbines have the advantage of eliminating, as much as possible, problems of friction between fixed parts and mobile parts, and thus of making optimal use of the current of air which animates them.

It is understood that, in the context of the present invention, the specification “magnetically levitated” does not preclude mechanical involvement in said levitation.

For a rotor diameter of approximately 18 metres, turbines of this type individually produce approximately 4000 kW/hour of power. Sixty such turbines can thus produce approximately 250 MW/hour.

In a preferred embodiment of the invention, the turbine assembly defines a circular region, and the generator assembly is arranged under said region.

So that the power station functions as well during the night as it does during the day, the floor of the collector is advantageously formed by a refractory pavement which can simply be formed of dry stones. Said pavement stores up heat during the day and returns it during the night, thereby maintaining a current of air which can operate the turbines. At night, the air in the collector is indeed less warm than during the day, but given that the temperature is also lower than during the day at the top of the chimney, the circulation of air is maintained.

Alternatively, or additionally, heat can be supplied during the night by a heat-transfer fluid circulating over or in the floor of the collector.

For this purpose, a circulation network can be embedded in the pavement of the floor of the collector, or run on the surface, and this network can be connected to a supply of water from a geothermal source. In this way, the heat supplied by geothermics is added to the heat stored by the refractory floor and heats the air contained in the collector.

The power station according to the invention will be particularly useful in an arid or desert-like environment, where the number of days of sunshine and the intensity of the sunshine are optimal. However, the disadvantage of such environments is that they generate dust or are subject to sand storms, which are harmful to the smooth operation of the power station if protection measures are not taken.

As a result, the distal end of the collector open to the surrounding environment will be protected against ingesting sand and/or dust.

The invention can be better understood by reading the following description with reference to the single FIGURE of the attached drawing, which is a partial schematic vertical section of the power station according to the invention.

As can be seen from said FIGURE, the power station comprises a chimney 1, the upper end 2 of which opens to the outside, and the lower end of which defines, about a roughly conical deflector 3 having a concave outer wall, a passage 4 connecting said chimney 1 to a collector 5. Said collector 5 substantially covers the shape of an open cylinder ring, towards the surrounding environment, at the outer periphery 6 thereof, referred to as the distal end. A series of vertical-axis turbines 7 is mounted, in a circle, between the inner periphery 8, referred to as the proximal end, of the collector 5 and the passage 4.

As a non-limiting example, the chimney can have a height of approximately 700 metres and a diameter of approximately 70 metres. It is self-evident that measures are taken during construction to ensure the stability of such a tower (such as the thickness varying from the base to the top, internal radial reinforcements etc.). The collector can have an external radius of approximately 750 metres and an average height of approximately 20 metres. More particularly, the collector 5 can have a height of approximately 10 metres at the outer periphery 6 thereof and a slope of approximately 2% between said outer periphery 6 and the inner periphery 8 thereof in order to ensure the drainage of rain water and condensed water.

The chimney can be made of concrete. Naturally, the upper wall of the collector 5 must be made of one or more heat-conductive materials so that the air contained in the collector is heated by the rays R of the sun S. An arrangement, preferably a radial arrangement, of metal sheets and translucent panels, for example made of zinc and PVC, would be suitable, but the invention is not limited to said choice. The floor of the collector 5 is paved with dry stones 10 over which a network of coils, such as 11, runs, which network is integrated into the floor and connected to a source of geothermal water.

As is also shown by the FIGURE, below the floor, under the region delimited by the circle of turbines 7, a generator assembly 12 is located, which assembly is connected to said turbines.

Opposite the open outer periphery 6 of the collector, protection means are provided which are intended to prevent the collector from ingesting dust or sand, such as a vegetable-based barrier 13, gabion 14, a metal guard-rail 15, an external trench 16a etc. arranged in a circle. An internal trench 16b, which is also circular, is also provided to collect the dust and the sand which may have entered the collector 5.

The operation of the power station is as follows:

In a manner known per se, the temperature drops with the altitude by approximately 1° C. per 100 m. If the chimney 1 has a height of 700 m, there is already, independently of any heating, a temperature difference of approximately 7° C. between the floor level and the top of the chimney. During the day, the sun heats the air located in the collector 5, which increases the temperature difference in question; a temperature difference which causes a current of air as indicated by the arrows F1. Said current of air makes the turbines 7 rotate, which turbines drive the power generator assembly 12. At the same time, the hot air located in the collector 5 heats the dry stones 10.

During the night, the air contained in the collector 5 is no longer heated by the solar rays, but the stones 10, which stored the heat, return it to the benefit of said air, as indicated by the arrows F2. Furthermore, additional heat is supplied by the geothermal water circulating in the network 11. A substantial temperature difference is thus maintained between the inside of the collector 5 and the top 2 of the chimney 1, such that the air continues to circulate, driving the turbines 7.

The power station can therefore operate 24 hours a day.

As can be seen from the above, the power station according to the invention allows the production of electrical energy by making use of natural and renewable resources and is particularly well suited to arid and desert-like regions.

1. Hybrid solar-wind power station of the type comprising a collector (5) of air heated by solar radiation (R, S) during the day, said collector having a distal end (6) open towards the surrounding environment, and an opposite, proximal end (8) in communication with a chimney (1), a series of turbines designed to drive an electric generator (12) assembly being interposed between said proximal end (8) and said chimney (1), characterised in that said turbines are magnetically levitated turbines (7) having a vertical axis of rotation.

2. Power station according to claim 1, characterised in that the turbine (7) assembly defines a circular region and in that said generator (12) assembly is arranged under said region.

3. Power station according to claim 1, characterised in that the floor of the collector (5) is formed by a refractory pavement (10).

4. Power station according to claim 1, characterised in that a network (10) for the circulation of heat-transfer fluid is embedded in, or runs over, the floor of the collector (5).

5. Power station according to claim 4, characterised in that said network (10) is designed to be connected to a supply of water from a geothermal source.

6. Power station according to claim 1, characterised in that the distal end (6) of the collector (5), which end is open towards the surrounding environment, is protected (13-16a) against ingesting sand and/or dust.

7. Power station according to claim 1, characterised in that, for a rotor diameter of approximately 18 metres, said turbines (7) individually produce a power of approximately 4000 kW/hour.

8. Power station according to claim 2, characterised in that the floor of the collector (5) is formed by a refractory pavement (10).

9. Power station according to claim 2, characterised in that a network (10) for the circulation of heat-transfer fluid is embedded in, or runs over, the floor of the collector (5).

10. Power station according to claim 3, characterised in that a network (10) for the circulation of heat-transfer fluid is embedded in, or runs over, the floor of the collector (5).

11. Power station according to claim 8, characterised in that a network (10) for the circulation of heat-transfer fluid is embedded in, or runs over, the floor of the collector (5).

12. Power station according to claim 2, characterised in that the distal end (6) of the collector (5), which end is open towards the surrounding environment, is protected (13-16a) against ingesting sand and/or dust.

13. Power station according to claim 3, characterised in that the distal end (6) of the collector (5), which end is open towards the surrounding environment, is protected (13-16a) against ingesting sand and/or dust.

14. Power station according to claim 4, characterised in that the distal end (6) of the collector (5), which end is open towards the surrounding environment, is protected (13-16a) against ingesting sand and/or dust.

15. Power station according to claim 5, characterised in that the distal end (6) of the collector (5), which end is open towards the surrounding environment, is protected (13-16a) against ingesting sand and/or dust.
